(19) United States
(12) Patent Application Publication
(10) Pub. No.: US 2018/0342224 A1
(43) Pub. Date: Nov. 29, 2018

(54) ELECTRONIC DEVICE, AND DISPLAY PANEL DEVICE CORRECTION METHOD AND SYSTEM THEREOF

(71) Applicant: SAMSUNG ELECTRONICS CO., LTD., Suwon-si, Gyeonggi-do (KR)

(72) Inventors: Nam-kyun BEON, Seoul (KR); Min-jung KIM, Seoul (KR); Sang-kyun IM, Seoul (KR)

(21) Appl. No.: 15/757,763

(22) PCT Filed: Sep. 2, 2016
(86) PCT No.: PCT/KR2016/009842

§ 371 Date: Mar. 6, 2018

(30) Foreign Application Priority Data
Sep. 23, 2015 (KR) 10-2015-0134455

(51) Int. Cl. G09G 5/10; G09G 3/32; G06T 7/00; G06T 7/90

(52) U.S. Cl. CPC G09G 5/10; G09G 3/32; G06T 7/0002; G06T 7/90; G09G 2360/16; G09G 2320/045; G06T 2207/30168; G09G 2320/0242; G09G 2320/0233; G09G 2360/145; G09G 2320/0626

(57) ABSTRACT

An electronic device is disclosed. The electronic device comprises: a storage for storing reference data including at least one of reference brightness and a reference color with respect to pixels constituting a display panel device; and a processor configured to compare an image taken from a preset video displayed on the display panel device with the reference data stored in the storage to calculate a target pixel area required to be corrected among pixel areas constituting a display panel and correction data for the target pixel area, thereby transmitting identification information of pixels included in the target pixel area and correction data to the display panel device.

### TECHNICAL FIELD

The present disclosure pertains to an electronic device, a display panel device thereof, a correction method of a display panel device, and a correction system and, more particularly to, an electronic device which transmits correction data to a display panel device to perform correction of the display panel device, a display device correction method and the correction system.

### BACKGROUND

As electronic technology has developed, various types of electronic devices have been developed and distributed. Among them, a display panel device is widely used in a general household, a company, an outdoor signage, and the like.

LED display panel device may have different brightness and color due to LED element characteristics of LED display panel. Accordingly, brightness and color non-uniformity may occur in the entire LED display panel device.

In order to solve the brightness and color unevenness of the LED display panel device, it is possible to correct the pixel of the LED display panel. In general, the correction of the pixel of the LED display panel is performed in a process of generating a module which constitutes an LED display panel device.

However, when time is elapsed after an LED display device of which brightness and color are corrected is installed, deterioration occurs to the LED device constituting the LED display panel device and brightness and color change. In this case, the degree of brightness and color change can vary according to the characteristics of each LED device.

Accordingly, brightness and color irregularities occur in the LED display panel device over time, and a method for calibrating the LED display panel device at a site (on-site) where the device is installed is required.

In the related art, the brightness and color of each pixel of the LED display panel device are measured using a measuring device, the correction data is calculated through measurement data, and the correction data is transmitted to the LED display panel device.

However, since the conventional correction method always transmits all the correction data for the pixels constituting the LED display panel device to the LED display panel device, it takes a long time to transmit the correction data, and thus the correction time of the LED display panel device is delayed.

In recent years, the resolution of the LED display panel device has been increasing, and a demand for a method of reducing the correction time of the LED display panel device has been further increased.

### DETAILED DESCRIPTION

### Tasks to be Solved

The present disclosure is purposed to provide an electronic device which transmits correction data for a pixel area requiring correction to a display panel device, panel device correction method and a correction system.

### Means for Solving Problems

An electronic device which communicates with a display panel device includes a storage for storing reference data including at least one of reference brightness and a reference color with respect to pixels constituting the display panel device; and a processor configured to compare an image taken from a preset video displayed on the display panel device with the reference data stored in the storage to calculate a target pixel area required to be corrected among pixel areas constituting the display panel and correction data for the target pixel area, thereby transmitting identification information of pixels included in the target pixel area and correction data to the display panel device.

The processor may calculate at least one of target brightness and target color of the target pixel area based on at least one of reference brightness and reference color included in the reference data, and calculate at least one difference value of at least one of the target brightness and the target color, and brightness and color included in the taken image as the correction data.

The processor may calculate at least one of target brightness of the target pixel area and the target color based on at least one of reference brightness and reference color included in the reference data and calculate at least one of the calculated target brightness and target color as the correction data.

An image which takes the display panel may be an image which takes the display panel in a driving state that is the same as a driving state of the display panel at a time when the reference data is measured.

The pixel area may be composed of at least one pixel, and the correction data comprises at least one of correction brightness and correction color with respect to each of sub-pixels included in at least one pixel of the target pixel area.

The image which takes the display panel may be an image which is taken using a colorimeter and at least one of brightness and color is measured.

The image which takes the display panel may be an image that is taken by a camera inside the electronic device or a camera outside the electronic device.

According to an exemplary embodiment, a correction system includes a display panel device; a measuring device which takes a preset image displayed on the display panel and measuring at least one of brightness and color corresponding to the image; and an electronic device which compares at least one of brightness and color corresponding to the image received from the measuring device with a prestored reference data to calculate a target pixel area requiring correction from among a pixel area constituting the display panel device and correction data with respect to the target pixel area, and transmits identification information of a pixel included in the target pixel area and the correction data to the display panel device.

A controlling method of an electronic device which communicates with a display panel device includes comparing an image which takes a preset image displayed on the display panel device with reference data which includes at least one of reference brightness and reference color of a pixel constituting the display panel device and reference and calculating a target pixel area which requires correction from among pixel areas constituting the display panel and correction data with respect to the target pixel area; and transmitting identification information of a pixel included in the target pixel area and the correction data to the display panel apparatus.

The calculating may include calculating at least one of target brightness and target color of the target pixel area based on at least one of reference brightness and reference color included in the reference data, and calculating at least one difference value of at least one of the target brightness and the target color, and brightness and color included in the taken image as the correction data.

The calculating may include calculating at least one of target brightness of the target pixel area and the target color based on at least one of reference brightness and reference color included in the reference data and calculates at least one of the calculated target brightness and target color as the correction data.

An image which takes the display panel may be an image which takes the display panel in a driving state that is the same as a driving state of the display panel at a time when the reference data is measured.

The pixel area may be composed of at least one pixel, and the correction data may include at least one of correction brightness and correction color with respect to each of sub-pixels included in at least one pixel of the target pixel area.

The image which takes the display panel may be an image which is taken using a colorimeter and at least one of brightness and color is measured.

The image which takes the display panel may be an image which is taken using a colorimeter and at least one of brightness and color is measured.

### Effect of Invention

As described above, according to various exemplary embodiments, correction data with respect to a target pixel area requiring correction can be calculated and transmitted to a display panel device and thus, time required for correction of a display panel can be minimized.

### BRIEF DESCRIPTION OF DRAWINGS

FIG. 1 illustrates a configuration of a correction system of a display panel device according to an exemplary embodiment.

FIG. 2 is a block diagram illustrating a configuration of an electronic device according to an exemplary embodiment.

FIGS. 3A and 3B are block diagrams illustrating a detailed configuration of an electronic device according to an exemplary embodiment.

FIG. 4 illustrates a method for calculating a target pixel area requiring correction according to an exemplary embodiment.

FIG. 5 is a flowchart for describing a correction method of a display panel device according to an exemplary embodiment.

FIG. 6 is a sequence map for describing an operation of the system for correcting a display panel device according to an exemplary embodiment.

### PREFERRED EMBODIMENTS

Hereinbelow, various exemplary embodiments will be described in a greater detail with reference to a drawing attached hereto.

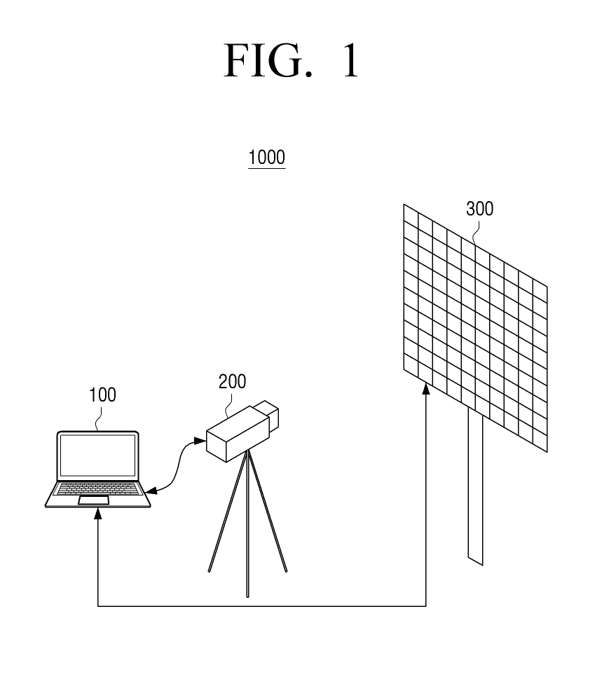

FIG. 1 illustrates a configuration of a correction system of a display panel device according to an exemplary embodiment.

As illustrated in FIG. 1, the display panel device correction system according to an exemplary embodiment includes an electronic device 100, a measuring device 200, and a display panel device 300.

The electronic device 100 may be implemented by various user terminal devices such as a PC, a laptop PC, a mobile phone, a tablet PC, and the like, but is not limited thereto. In addition, the electronic device 100 may be implemented as an apparatus that performs only display panel device correction.

The measuring device 200 may be implemented by a camera, a colorimeter, or the like. In general, a camera-type colorimeter is used to measure the brightness and color of the pixels of the display panel apparatus 300. Here, the camera-type colorimeter is composed of a CCD sensor, a lens, a body, and the like, and can measure the brightness and color of the pixels of the display panel device 300 from images photographed by the camera. The brightness and color for the pixels of the measured display panel device 300 can be stored as data in the form of Lv (luminance), x, y coordinates or X, Y, Z coordinates.

In addition, the measuring device 200 can measure the brightness and color of the pixels of the display panel device 300 by photographing the display panel in the same driving state as the driving state of the display panel at the time when the reference data is measured. Specifically, the measuring device 200 photographs an image of a predetermined display pattern (for example, a pattern in which red, green, and blue are displayed in a full color) on a display panel, and brightness and color per each measured pattern can be measured. In this case, the electronic device 100 can calculate the correction data by comparing the brightness and color measured by the measuring device 200 with the reference data.

The measuring device 200 may be separate from the electronic device 100 or may be located inside the electronic device 100. In addition, the measuring device 200 may be combined with the electronic device 100 to constitute a single device. That is, one device in which the electronic device 100 and the measuring device 200 are combine may photograph a preset image displayed on the display panel device 300 and calculate correction data by comparing with reference data.

Meanwhile, the electronic device 100 may perform correction for each pixel of the display panel device 300 according to the degree of uniformity of brightness and color of the display panel device 300 measured by the measuring device 200. For example, the electronic device 100 may compare the reference brightness and the reference color corresponding to the image obtained by photographing the image on which the red color is displayed on the display panel, compare the reference brightness and the reference color corresponding to the image obtained by photographing the image on which the green color is displayed on the display panel, and compare the reference brightness and the reference color corresponding to the image obtained by photographing the image on which the blue color is displayed on the display panel to calculate correction data.

In particular, the electronic device 100 compares the captured image of the predetermined image displayed on the display panel device 300 by the measuring device 200 with the reference data stored in the storage, to calculate a target pixel area that needs correction among the pixel areas constituting the panel of the display panel device 300.

Specifically, the electronic device 100 may measure the brightness and color of the pixel in the photographed image, and if a value of the measured brightness and color is different from a value of the prestored reference brightness and reference color for more than a predetermined value, may determine that a pixel requires correction.

In addition, when the electronic device 100 has a plurality of pixels requiring correction, the electronic device 100 may determine an area including a plurality of pixels requiring correction as a target pixel area. Then, the electronic device 100 may calculate correction data for the calculated target pixel area, and transmit the identification information of the pixels included in the target pixel area and the calculated correction data to the display panel device 300.

In addition, the electronic device 100 may calculate correction data on a unit of modules constituting the display panel device 300. When the module of the display panel device 300 is replaced, the electronic device 100 may calculate correction data for pixels included in the replaced module and transmit the correction data to the display panel device 300.

Specifically, the electronic device 100 can calculate the correction data by comparing the brightness and color measured in the replaced module with the pre-stored reference brightness and reference color, and calculate the target pixel area that needs to be corrected in the replaced module. The electronic device 100 transmits the correction data for the replaced module and the identification information of the pixels included in the target pixel area to the display panel device 300 so that the display panel device 300 may perform correction for the pixels constituting the display panel.

In addition, the electronic device 100 may calculate the correction data in units of sub-blocks of the display panel device 300. In this case, the electronic device 100 may calculate the correction data on a sub-area basis and output the correction data to the display panel device 300. Specifically, the electronic device 100 compares the brightness and color measured in the image taken in the predetermined image displayed on the display panel device with the previously stored reference brightness and the reference color to determine a target sub-area requiring correction and correction data for the target sub-area.

For example, when the difference between the measured brightness and color; and the previously stored reference brightness and the reference color is equal to or greater than a predetermined value, the electronic device 100 may determine that the target sub-area needs to be corrected and calculate correction data for the target sub-area. Then, the electronic device 100 can transmit the identification information of the pixels included in the target sub-area and the correction data for the target sub-area to the display panel device 300. Here, the identification information of the pixels included in the target sub-area may be position information on the pixel determined to be necessary for correction because the measured brightness and color are different from the reference brightness and reference color by a predetermined value or more.

The display panel device 300 performs correction for the uniformity of the display panel using the identification information of the pixels included in the target pixel area received from the electronic device 100 and the calculated correction data. Specifically, the display panel device 300 determines the position of the pixel on which correction is to be performed based on the pixel identification information transmitted from the electronic device 100. The display panel device 300 extracts the brightness and color values of the pixels to be corrected and multiplies the extracted brightness and color values by the correction data values received from the electronic device 100, to perform correction for the pixel constituting the display panel.

The display panel device 300 generally includes a light emitting diode (LED) panel, but is not limited thereto. The display panel device 300 may include various display panels requiring uniformity correction such as an organic light emitting diode (OLED).

As described above, the display panel device correction system transmits the correction data for the pixel area requiring correction to the display panel device 300 to perform correction of the display panel, and thus may shorten the time consumed for correction of the display panel.

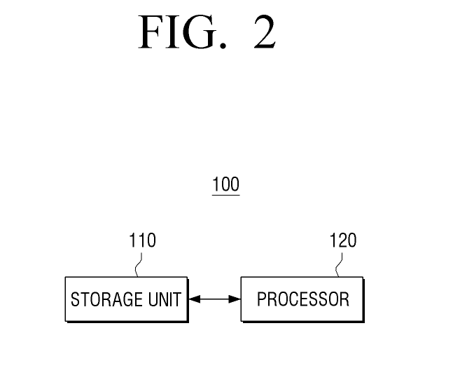

FIG. 2 is a block diagram illustrating a configuration of an electronic device according to an exemplary embodiment.

Referring to FIG. 2, the electronic device 100 according to an exemplary embodiment includes the storage 110 and the processor 120.

The storage 110 stores reference data including at least one of a reference brightness and a reference color for the pixels constituting the display panel device 300. Here, the reference brightness and the reference color may be represented by values corresponding to the sub-pixels R, G, and B included in the pixels constituting the display panel device 300. Specifically, the reference brightness for one pixel may be represented by the brightness values of the sub-pixels R, G, and B, and the reference color for one pixel is represented by the color values of the sub-pixels R, G, B. Alternatively, the reference brightness and reference color for one pixel can be represented by a specific value that displays the brightness and color of the subpixels R, G, B at one time. Hereinafter, it is assumed that the reference brightness and the reference color for one pixel are represented by specific values that display the brightness and color of the sub-pixels R, G, and B at one time. That is, the reference brightness and the reference color for one pixel can be represented by the values of the sub-pixels R, G, and B, and the reference data including at least one of the reference brightness and the reference color.

The reference brightness and reference color for the pixels constituting the display panel device 300 may be the values stored in the display panel device 300 after performing correction for pixels in the process of the display panel device 300, or the value stored in the display panel device 300 after the device 300 has performed the most recent correction.

The storage 110 may store reference data including at least one of a reference brightness and a reference color for the pixels constituting the display panel device 300 through receiving the value stored in the display panel device 300 or through user input. In general, the reference data may be a value for R, G, B constituting the subpixel, but is not limited thereto. In addition to the values for R, G and B, values for W (white) and values for Y (yellow) values, etc. can be further included.

The processor 120 may compare the image of the predetermined image displayed on the display panel device 300 with the reference data stored in the storage 110 and calculate a target pixel area that needs to be corrected among the pixel areas constituting the display panel. Specifically, the processor 120 compares the subpixel value extracted from the image captured in the preset image displayed on the display panel device 300 with the subpixel value included in the previously stored reference data, and if the difference of the value is greater than the preset value, it can be determined that the area corresponds to the target pixel area.

The processor 120 may calculate correction data for the target pixel area if the target pixel area is determined. Specifically, the correction data can be calculated based on the measured brightness and color of the target pixel area, the target brightness, and the target color. Here, the correction data can generally have the form of a 3×3 color matrix as shown below.

$$( \begin{matrix}{R}^{′} \\ {G}^{′} \\ {B}^{′}\end{matrix} ) = ( \begin{matrix}{C}_{RR} & {C}_{RG} & {C}_{RB} \\ {C}_{GR} & {C}_{GG} & {C}_{GB} \\ {C}_{BR} & {C}_{BG} & {C}_{BB}\end{matrix} ) ( \begin{matrix}R \\ G \\ B\end{matrix} )$$

Here, R′, G′, and B′ indicate target brightness and color, R, G, and B indicate brightness and color included in a photographed image, and CRR˜CBB are correction data.

As shown in the drawing above, when the correction data has a 3×3 color matrix, correction data can be made up of nine data. For example, when the display panel device 300 has a resolution of FHD (1920*1080), correction data of 9*1920*1080=18662400 size is required. Accordingly, when the correction data for all the pixels constituting the display panel device 300 are to be transmitted, the correction data of about 19 M should be transmitted. On the other hand, when the processor 120 transmits only the correction data corresponding to the target pixel area, the size of the correction data to be transmitted can be reduced, and the time required for the display panel correction can be shortened. However, it is described that one pixel has three subpixels of R, G, and B, but the subpixels may include four subpixels such as R/G/B/W and R/G/B/Y. In this case, one pixel may be composed of five or more subpixels.

The processor 120 may calculate at least one of a target brightness and a target color of the target pixel area based on at least one of the reference brightness and the reference color included in the reference data. Specifically, the processor 120 may calculate the target brightness and the target color equally with the reference brightness and the reference color, or may calculate the target brightness and the target color similar to the reference brightness and the reference color. Alternatively, when the target brightness and the target color are input from a user, the input values may be calculated as the target brightness and the target color.

The processor 120 may calculate correction data in units of modules constituting the display panel device 300. When the module of the display panel device 300 is replaced, the processor 120 may calculate the correction data for the pixels included in the replaced module and transmit the correction data to the display panel device 300. Specifically, the processor 120 may compare the brightness and color measured in the replaced module with the reference brightness and the reference color stored in the storage 110 to calculate correction data, and determine a target pixel area to be corrected in the replaced module. The processor 120 may transmit the correction data for the replaced module and the identification information of the pixels included in the target pixel area to the display panel device 300 so that the display panel device 300 may perform the correction for the pixels constituting the display panel.

In addition, the processor 120 may calculate the correction data on a sub-area basis for the display panel device 300. In this case, the processor 120. When the pixel constituting the display panel device 300 is corrected, the correction can be performed in the units of sub-areas. The processor 120 may calculate the correction data in the units of a sub-area and transmit the correction data to the display panel device 300. To be specific, the processor 120 may compare brightness and color measured from an image which photographs a preset image displayed on the display panel device with the reference brightness and color stored in the storage 110 and calculate correction data with respect to a sub area requiring correction and correction data for the target sub-area.

For example, when the difference between the measured brightness and color and the reference brightness and the reference color stored in the storage 110 are equal to or greater than a predetermined value, the processor 120 may determine that the target sub-area requiring correction and calculate correction data for the target sub area. Then, the processor 120 may transmit the identification information of the pixels included in the target sub-area and the correction data for the target sub-area to the display panel device 300. Here, the identification information of the pixels included in the target sub-area may be positional information on pixels determined to be necessary for correction because the measured brightness and color differ from the reference brightness and reference color by a predetermined value or more.

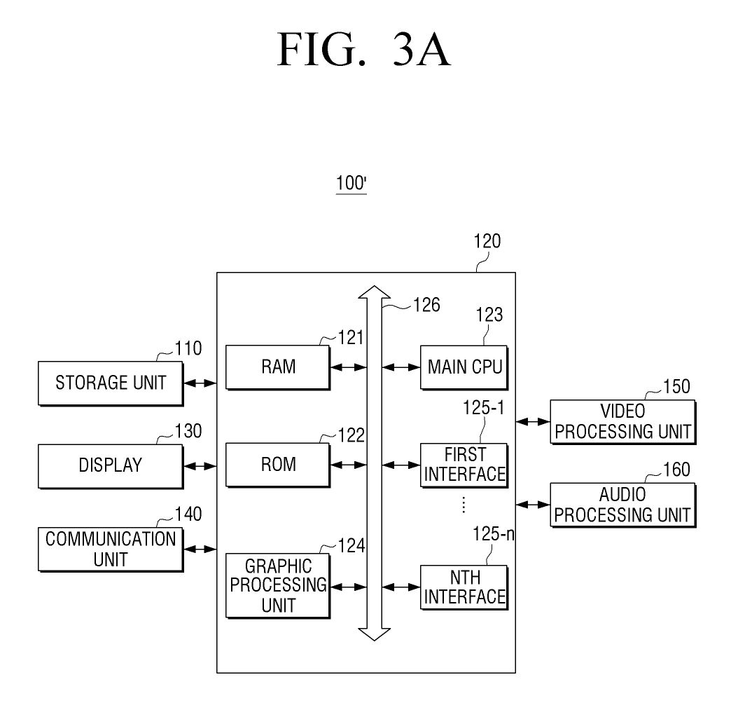

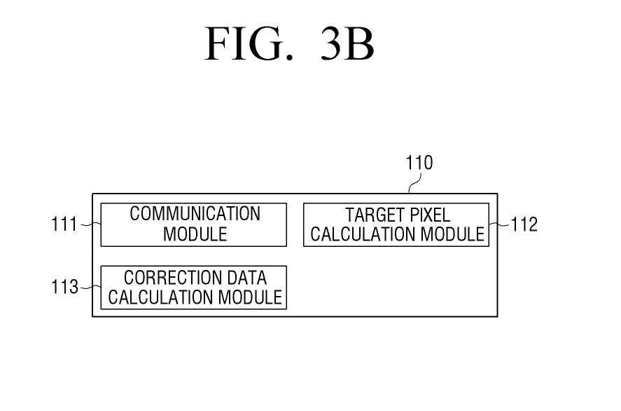

FIGS. 3A and 3B are block diagrams illustrating a detailed configuration of an electronic device according to an exemplary embodiment.

According to FIG. 3A, an electronic device 100′ includes the storage 110, the processor 120, the display 130, the communication unit 140, a video processing unit 150, and an audio processing unit 160. A detailed description of parts overlapping with those shown in FIG. 2 among the components shown in FIG. 3A will be omitted.

The processor 120 controls overall operations of the electronic device 100′.

To be specific, the processor 120 includes RAM 121, ROM 122, main CPU 123, a graphic processing unit 124, first to nth interface 125-1˜125-n, and bus 126.

The RAM 121, ROM 122, the main CPU 123, the graphic processing unit 124, and the first to nth interface 125-1˜125-n may be interconnected through the bus 126.

The first to nth interface 125-1˜125-n are connected to the aforementioned various elements. One of the interfaces may be network interface connected to an external device through network.

The main CPU 123 accesses the storage 110 and performs booting using the 0/S stored in the storage 110. The main CPU 123 may perform various operations using various programs, contents, data, and the like stored in the storage 110.

The ROM 122 stores a command set for booting the system and the like. When the turn-on command is input and power is supplied, the main CPU 123 copies the 0/S stored in the storage 110 to the RAM 121 according to the command stored in the ROM 122, and executes 0/S for booting the system. When the booting is completed, the main CPU 123 copies various application programs stored in the storage 110 to the RAM 121, executes the application program copied to the RAM 121, and performs various operations.

The graphic processing unit 124 may use an operation unit (not shown) and a rendering unit (not shown) to display a screen including various objects such as an icon, an image, text and the like, for example, a screen including an object indicating brightness and color of each pixel of the display panel device. The operation unit (not shown) computes the target brightness and target color of the target pixel area based on the received control command, or sets the brightness and color inputted from the user as the target brightness and the target color. The rendering unit (not shown) generates a screen including the object based on the target brightness and the target color calculated by an operation unit (not shown). The screen generated in the rendering unit (not shown) may be displayed in the user interface area.

In the meantime, the operations of the processor 120 may be performed by a program stored in the storage 110 as illustrated in FIG. 3C.

The storage 110 stores various data such as operating system (O/S) software module and multimedia contents to operate the electronic device 100′.

In particular, the storage 110 hay store a program which includes a communication module 111, a target pixel calculation module 112, and a correction data calculation module 113 according to an exemplary embodiment as illustrated in FIG. 3B.

The processor 120 may receive an image from the measuring device 200 using the communication module 111 and transmit the calculated correction data to the display panel device 300.

For example, when the processor 120 receives an image of a preset image displayed on the display panel device 300 from the measuring device 200, a target pixel area requiring correction is calculated using the target pixel calculating module 112. Thereafter, correction data for the target pixel area calculated using the correction data calculation module 113 is calculated, and identification information and correction data of the pixels included in the target pixel area are transmitted to the display panel device 300.

The display 130 may be implemented as various types of displays such as liquid crystal display, organic light-emitting diode), Liquid Crystal on Silicon (LCoS), Digital Light Processing (DLP), or the like.

The communication unit 140 communicates with the measuring device 200 or the display panel device 300. The communication unit 140 may communicate with the measuring device 200 or the display panel device 300 through various communication methods such as BlueTooth (BT), wireless fidelity (WI-FI), Zigbee, IR, Serial Interface, Universal Serial Bus (USB), near field communication (NFC) and the like. Also, the communication unit 140 can perform communication with the measuring device 200 or the display panel device 300 in a wired communication mode in addition to wireless communication.

In addition, the electronic device 100′ may further include a video processing unit 150 for performing processing on video data, an audio processing unit 160 for performing processing on audio data, a speaker for outputting various audio sounds or voice messages processed by the audio processing unit 160, a camera for photographing a still image or a moving picture according to a user's control, and a microphone for receiving a user's voice or other sounds and converting the received voice or sounds data into audio data, and the like.

In the above-described embodiment, it is described that calculating the correction data for the target pixel area is performed in the electronic device 100′. However, this is merely an example, and the correction data calculation may be performed by an algorithm for calculating correction data stored in the display panel device 300.

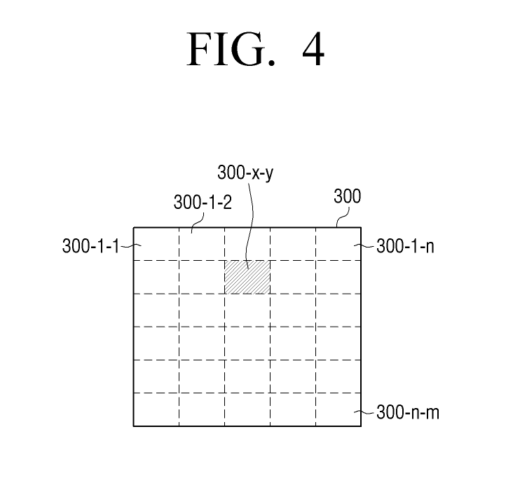

FIG. 4 illustrates a method for calculating a target pixel area requiring correction according to an exemplary embodiment.

Referring to FIG. 4, the processor 120 may compare a predetermined image displayed on the display panel device 300 with reference data stored in the storage 110, and calculate a target pixel area 300-x-y which requires correction from among pixel areas constituting the display panel.

For example, the display panel device 300 may be divided into a plurality of pixel areas 300-1-1, 300-1-2, . . . , 300-1-m, . . . , 300-n-m. Here, the plurality of pixel areas 300-1-1, 300-1-2, . . . , 300-1-m, . . . , 300-n-m may be a module constituting the display panel device 300. Further, the plurality of pixel areas 300-1-1, 300-1-2, . . . , 300-1-m, . . . , 300-n-m may be an area formed by a group of pixels requiring correction, or an arbitrarily set area by a user, but is not limited thereto and may be an area set in various ways.

For example, when the plurality of pixel areas 300-1-1, 300-1-2, . . . , 300-1-m, . . . , 300-n-m are modules that constitute the display panel device 300, if some modules of the display panel device 300 are replaced, the processor 120 can calculate the correction data of the replaced module and transmit the calculated correction data to the display panel device 300.

Specifically, the processor 120 extracts reference data of a pixel area corresponding to the replaced module. In this case, the reference data may be reference brightness and reference color with respect to the pixels constituting the display panel device 300 stored in the storage 110 when the display panel device 300 is installed or during the producing process of the display panel device 300.

The processor 120 may then calculate the target brightness and target color based on the brightness and color measured in the area except for the replaced module area. In this case, the target brightness and target color can also be set through user input and can generally have values of Lv (luminance), x, y or X, Y, Z.

The processor 120 may calculate correction data for the replaced module area by comparing the reference brightness included in the reference data of the replaced module area and the target brightness and target color with the reference color. In this case, the correction data may be in the form of a 3×3 matrix.

The processor 120 may transmit the correction data calculated for the replaced module area to the display panel device 300 and the display panel device 300 can perform the correction of the display panel using the transmitted correction data. According to an exemplary embodiment of the present invention, since the electronic device 100 transmits only the correction data for the replaced module area to the display panel device 300, the transmission time can be reduced and thus, time required for correction of the display panel device 300 can be shortened.

As still another example, a plurality of pixel areas 300-1-1, 300-1-2, . . . , 300-1-m, . . . , 300-n-m can be a part of an area of the display panel device 300. In this case, correction data can be calculated in the same manner as the case where the plurality of pixel areas 300-1-1, 300-1-2, . . . , 300-1-m, . . . , 300-n-m are the module areas of the display panel apparatus 300. The correction data can be calculated similarly to the case. Specifically, the processor 120 calculates the brightness and color of the pixels constituting each pixel area from the image of the display panel, compares the calculated brightness and color with the reference brightness and the reference color included in the pre-stored reference data. In this case, the target pixel area may be set as am area in the case where there are more than a predetermined number of pixels of which difference between the calculated brightness and the reference brightness; and the calculated color and the reference color is greater than a predetermined value.

The processor 120 may calculate correction data for a target pixel area that needs to be corrected. In this case, the correction data may have a 3×3 matrix form, but is not limited thereto. The processor 120 may transmit the identification information of the pixels included in the target pixel area and the correction data for the target pixel area to the display panel device 300 and the display panel device 300 may transmit the correction data for the target pixel area. The correction of the display panel can be performed using the identification information of the pixel included in the received target pixel area and the correction data for the target pixel area.

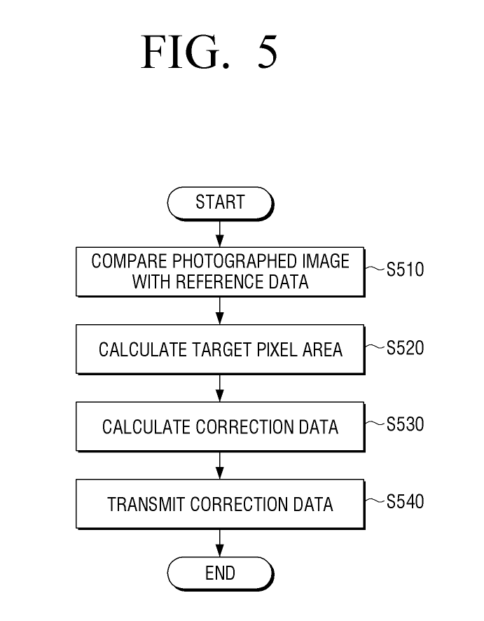

FIG. 5 is a flowchart for describing a correction method of a display panel device according to an exemplary embodiment.

Referring to FIG. 5, a photographed image and reference data are compared in step S510, and a target pixel area is calculated in step S520. Here, the photographed image is an image which takes a predetermined image displayed on the display panel device, and the reference data is data including at least one of a reference brightness and a reference color for the pixels constituting the display panel device. Further, the target pixel area may mean an area requiring correction among pixel areas constituting the display panel.

The correction data is calculated in step S530. Here, correction data regarding the calculated target pixel area can be calculated or the correction data regarding a pixel area constituting the display panel can be calculated.

Then, identification information of a pixel included in a target pixel area and correction data are transmitted to a display panel device in step S540.

Also, in step S530, at least one of the target brightness and the target color of the target pixel area is calculated based on at least one of the reference brightness and the reference color included in the reference data, and a difference between at least one of the target brightness and the target color and at least one of brightness and color included in a photographed image can be calculated as correction data.

Also, in step S530, at least one of the target brightness and the target color of the target pixel area is calculated based on at least one of the reference brightness and the reference color included in the reference data, and at least one of the calculated target brightness and target color can be calculated as correction data.

In addition, in step S510, the image of the display panel which photographs a display panel may be an image of the display panel photographed in the same driving state as the driving state of the display panel at the time of measuring the reference data.

Also, in S530 and S540, the pixel area is composed of at least one pixel, and the correction data may include at least one of correction brightness and correction color for each of the subpixels included in at least one pixel included in the target pixel area.

In addition, in step S510, an image which photographs a display panel may be an image which photographs at least one of brightness and color photographed using a colorimeter.

Further, in step S510, an image which photographs a display panel may be an image which is photographed by a camera inside the electronic device or a camera outside the electronic device.

In the meantime, the methods according to various exemplary embodiments can be implemented only by upgrading software of the electronic device.

In addition, a non-transitory computer readable medium in which a program sequentially performing a correction method can be provided.

As an example, a non-transitory computer readable medium in which a program is stored can be provided. Here, the program performs a step of comparing brightness and color measured from an image which photographs a preset image displayed on the display panel device with the reference brightness and color and calculating correction data with respect to a sub area requiring correction and correction data for the target sub-area and transmitting identification of a pixel included in the target pixel area and correction data to the display panel device.

The non-transitory computer-recordable medium is not a medium configured to temporarily store data such as a register, a cache, or a memory but an apparatus-readable medium configured to semi-permanently store data. Specifically, the above-described various applications or programs may be stored in the non-transitory apparatus-readable medium such as a compact disc (CD), a digital versatile disc (DVD), a hard disc, a Blu-ray disc, a universal serial bus (USB), a memory card, or a read only memory (ROM), and provided therein.

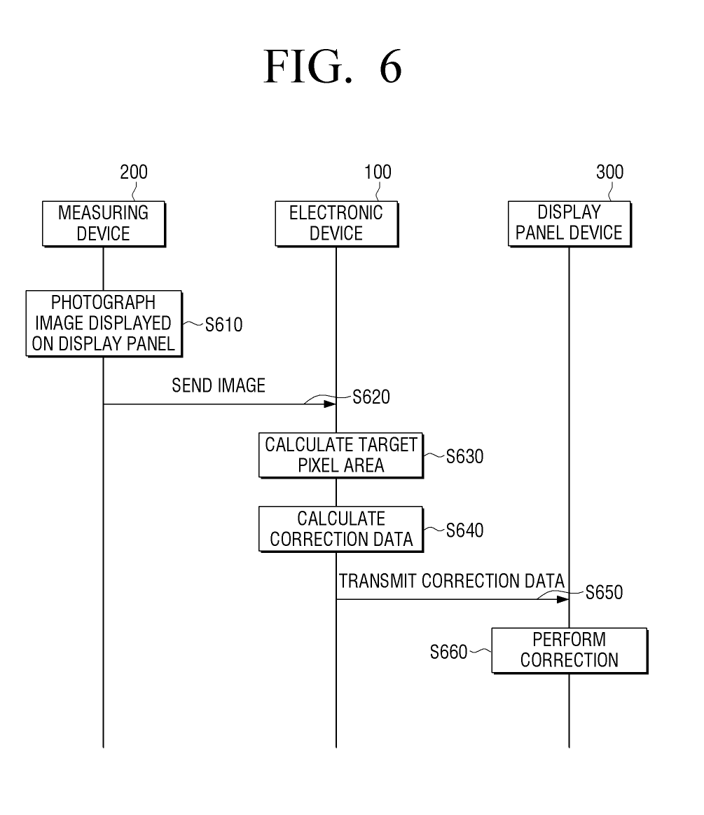

FIG. 6 is a sequence map for describing an operation of the system for correcting a display panel device according to an exemplary embodiment.

Referring to FIG. 6, the measuring device 200 measures at least one of the brightness and the color corresponding to the image by photographing a predetermined image displayed on the display panel in step S610, and transmits at least one of the measured brightness and color to the electronic device 100 in step S620. However, the measuring device 200 transmits the image of the predetermined image displayed on the display panel to the electronic device 100, and transmits at least one of brightness and color based on the photographed image transmitted from the electronic device 100.

The electronic device 100 may compare at least one of brightness and color corresponding to a predetermined image displayed on the display panel received from the measuring device 200 with previously stored reference data, and calculate a target pixel area that needs to be corrected in step S630. Thereafter, the electronic device 100 may calculate correction data for the calculated target pixel area in step S640, and transmit the identification information of the pixels included in the target pixel area and the calculated correction data to the display panel device 300 in step S650.

As another example, the electronic device 100 may calculate correction data on a module basis of the display panel device 300. When the module of the display panel device 300 is replaced, the electronic device 100 may calculate the correction data for the pixels included in the replaced module and transmit the correction data to the display panel device 300. Specifically, the electronic device 100 can calculate the correction data by comparing the measured brightness and color in the replaced module with the previously stored reference brightness and reference color, and calculate the target pixel area that needs to be corrected in the replaced module. The electronic device 100 transmits the correction data for the replaced module and the identification information of the pixels included in the target pixel area to the display panel device 300 so that the display panel device 300 displays the correction data for the pixels constituting the display panel, thereby allowing correction of the pixels constituting the display panel.

As another example, the electronic device 100 may calculate the correction data on a sub-area basis for the display panel device 300. In this case, when a pixel constituting the display panel device 300 is corrected, the correction can be performed in a sub-area unit. The electronic device 100 may calculate correction data in units of a sub area and transmit correction data to the display panel device 300. Specifically, the electronic device 100 may compare the measured brightness and color in the image taken in the predetermined image displayed on the display panel device with the previously stored reference brightness and reference color, and calculate the correction data.

The display panel apparatus 300 performs correction of a display panel based on identification information of a pixel included in a target pixel area received from the electronic device 100 and the calculated correction data in step S660.

The display panel device 300 determines the position of the pixel on which correction is to be performed based on the pixel identification information transmitted from the electronic device 100. The display panel device 300 extracts the brightness and color values of the pixels to be corrected and perform correction on a panel constituting the display panel by multiplying the extracted brightness and color values by the correction data values received from the electronic device 100.

As described above, according to various embodiments of the present invention, correction data for a target pixel area requiring correction can be calculated and transmitted to the display panel device, thereby minimizing the time required for the display panel device correction.

The foregoing exemplary embodiments and advantages are merely exemplary and are not to be construed as limiting the inventive concept. The exemplary embodiments may be readily applied to other types of device or apparatus. Also, the description of the exemplary embodiments is intended to be illustrative, and not to limit the scope of the inventive concept, and many alternatives, modifications, and variations will be apparent to those skilled in the art.

What is claimed is:

1. An electronic device which communicates with a display panel device, the device comprising:
a storage for storing reference data including at least one of reference brightness and a reference color with respect to pixels constituting the display panel device; and
a processor configured to compare an image taken from a preset video displayed on the display panel device with the reference data stored in the storage to calculate a target pixel area required to be corrected among pixel areas constituting the display panel and correction data for the target pixel area, thereby transmitting identification information of pixels included in the target pixel area and correction data to the display panel device.

2. The device of claim 1, wherein the processor calculates at least one of target brightness and target color of the target pixel area based on at least one of reference brightness and reference color included in the reference data, and calculates at least one difference value of at least one of the target brightness and the target color, and brightness and color included in the taken image as the correction data.

3. The device of claim 1, wherein the processor calculates at least one of target brightness of the target pixel area and the target color based on at least one of reference brightness and reference color included in the reference data and calculates at least one of the calculated target brightness and target color as the correction data.

4. The device of claim 1, wherein an image which takes the display panel is an image which takes the display panel in a driving state that is the same as a driving state of the display panel at a time when the reference data is measured.

5. The device of claim 1, wherein the pixel area is composed of at least one pixel, and the correction data comprises at least one of correction brightness and correction color with respect to each of sub-pixels included in at least one pixel of the target pixel area.

6. The device of claim 1, wherein the image which takes the display panel is an image which is taken using a colorimeter and at least one of brightness and color is measured.

7. The device of claim 1, wherein the image which takes the display panel is an image that is taken by a camera inside the electronic device or a camera outside the electronic device.

8. A correction system comprising:
a display panel device;
a measuring device which takes a preset image displayed on the display panel and measuring at least one of brightness and color corresponding to the image; and
an electronic device which compares at least one of brightness and color corresponding to the image received from the measuring device with a prestored reference data to calculate a target pixel area requiring correction from among a pixel area constituting the display panel device and correction data with respect to the target pixel area, and transmits identification information of a pixel included in the target pixel area and the correction data to the display panel device.

9. A controlling method of an electronic device which communicates with a display panel device, the method comprising:
comparing an image which takes a preset image displayed on the display panel device with reference data which includes at least one of reference brightness and reference color of a pixel constituting the display panel device and reference and calculating a target pixel area which requires correction from among pixel areas constituting the display panel and correction data with respect to the target pixel area; and
transmitting identification information of a pixel included in the target pixel area and the correction data to the display panel apparatus.

10. The method of claim 9, wherein the calculating comprises calculating at least one of target brightness and target color of the target pixel area based on at least one of reference brightness and reference color included in the reference data, and calculating at least one difference value of at least one of the target brightness and the target color, and brightness and color included in the taken image as the correction data.

11. The method of claim 9, wherein the calculating comprises calculating at least one of target brightness of the target pixel area and the target color based on at least one of reference brightness and reference color included in the reference data and calculates at least one of the calculated target brightness and target color as the correction data.

12. The method of claim 9, wherein an image which takes the display panel is an image which takes the display panel in a driving state that is the same as a driving state of the display panel at a time when the reference data is measured.

13. The method of claim 9, wherein the pixel area is composed of at least one pixel, and the correction data comprises at least one of correction brightness and correction color with respect to each of sub-pixels included in at least one pixel of the target pixel area.

14. The method of claim 9, wherein the image which takes the display panel is an image which is taken using a colorimeter and at least one of brightness and color is measured.

15. The method of claim 9, wherein the image which takes the display panel is an image that is taken by a camera inside the electronic device or a camera outside the electronic device.
